(19) United States
(12) Patent Application Publication
(10) Pub. No.: US 2026/0058510 A1
(43) Pub. Date: Feb. 26, 2026

(54) ROTOR, ROTATING ELECTRIC MACHINE, AND DRIVE DEVICE

(71) Applicant: NIDEC CORPORATION, Kyoto (JP)

(72) Inventor: Atsushi SUGAYA, Kyoto (JP)

(21) Appl. No.: 19/104,672

(22) PCT Filed: Aug. 9, 2023
(86) PCT No.: PCT/JP2023/029172

§ 371 Date: Feb. 18, 2025

(30) Foreign Application Priority Data
Nov. 30, 2022 (JP) 2022-191774

(51) Int. Cl. H02K 1/276; H02K 1/30; H02K 1/32

(52) U.S. Cl. CPC H02K 1/276; H02K 1/30; H02K 1/32; H02K 2213/03

(57) ABSTRACT

A rotor core includes a through hole, a projection at an inner edge of the through hole, and recesses along the inner edge. The total number of the projecting portion and the recesses is N. Among N virtual lines extending radially outwardly from a central axis and arranged at equal intervals in a circumferential direction, one of the virtual lines overlaps the center in the circumferential direction of the projection. The recesses include a first recess and a second recess overlapping the virtual line. In the circumferential direction, the first recess satisfies at least one of: the first recess has a relationship with the virtual line closest to the first recess different from a relationship of the second recess with the virtual line overlapping the second recess; the first recess has a shape different from the second recess; or the first recess has a dimension different from the second recess.

### CROSS-REFERENCE TO RELATED APPLICATIONS

This is the U.S. national stage of application No. PCT/JP2023/029172, filed on Aug. 9, 2023, and priority under 35 U.S. C. § 119(a) and 35 U.S. C. § 365(b) is claimed from Japanese Patent Application No. 2022-191774, filed on Nov. 30, 2022.

### FIELD OF THE INVENTION

The present invention relates to a rotor, a rotating electric machine, and a drive device.

### BACKGROUND

A shaft body with a core portion for a rotating electric machine including a core portion having a protruding portion corresponding to a key groove provided in a shaft body is known. For example, a core portion having a pair of protruding portions with a shaft body interposed between them is known.

In the shaft body with a core portion for a rotating electric machine as described above, since it is necessary to provide a pair of key grooves in the shaft body, manufacturing cost of the shaft body may increase. On the other hand, when the key groove and the protruding portion are provided one by one, it is possible to suppress increase in manufacturing cost of the shaft body. However, in this case, since the key groove and the protruding portion are provided, the weight balance in a circumferential direction of the shaft body with a core portion is lost, and the center of gravity of the shaft body with a core portion may be displaced with respect to a rotation center of the shaft body with a core portion. For this reason, when the shaft body with a core portion rotates in a rotating electric machine, there has been a possibility that vibration of the shaft body with a core portion becomes large, and noise is generated.

### SUMMARY

One aspect of the rotor of the present invention is a rotor rotatable about a central axis, and includes a shaft extending in an axial direction and a rotor core fixed to the shaft. The rotor core includes a through hole through which the shaft passes in the axial direction, a projecting portion provided at a radially inner edge portion of the through hole and protruding to the inner side in a radial direction, and a plurality of recessed portions provided at intervals in a circumferential direction at a radially inner edge portion of the through hole and recessed to the outer side in the radial direction. When a plurality of virtual lines extending to an outer side in the radial direction from a central axis and arranged at equal intervals in the circumferential direction when viewed in the axial direction and as many as the total number of the number of the projecting portions and the number of the recessed portions are defined, one of a plurality of the virtual lines overlaps the center in the circumferential direction of the projecting portion when viewed in the axial direction. A plurality of the recessed portions include a first recessed portion and a second recessed portion overlapping the virtual line when viewed in the axial direction. The first recessed portion satisfies at least one of the following conditions: the first recessed portion has an arrangement relationship in the circumferential direction with respect to the virtual line closest to the first recessed portion in the circumferential direction when viewed in the axial direction that is different from an arrangement relationship in the circumferential direction of the second recessed portion with respect to the virtual line overlapping the second recessed portion; the first recessed portion has a shape different from that of the second recessed portion when viewed in the axial direction; and the first recessed portion has a dimension in the circumferential direction different from that of the second recessed portion when viewed in the axial direction.

One aspect of a rotating electric machine according to the present invention includes the rotor described above, and a stator facing the rotor with a gap interposed between them in a radial direction.

One aspect of a drive device of the present invention includes the rotating electric machine described above, and a gear mechanism connected to the rotating electric machine.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a diagram schematically illustrating a drive device according to a first embodiment;

FIG. 2 is a cross-sectional view illustrating a rotor in the first embodiment;

FIG. 3 is a cross-sectional view illustrating a part of a rotor core in the first embodiment;

FIG. 4 is a cross-sectional view illustrating a laminated body in the first embodiment;

FIG. 5 is a cross-sectional view illustrating a part of the rotor core in a second embodiment; and

FIG. 6 is a cross-sectional view illustrating a part of the rotor core in a third embodiment.

### DETAILED DESCRIPTION

Description below will be made with a vertical direction being defined based on a positional relationship in a case where a drive device of an embodiment is mounted in a vehicle located on a horizontal road surface. That is, a relative positional relationship regarding the vertical direction described in the embodiment below only needs to be satisfied at least in a case where the drive device is mounted on a vehicle located on a horizontal road surface.

The drawings illustrate an XYZ coordinate system appropriately as a three-dimensional orthogonal coordinate system. In the XYZ coordinate system, a Z axis direction is the vertical direction. A +Z side is a vertically upper side, and a −Z side is a vertically lower side. In description below, a vertically upper side will be simply referred to as “upper side” and a vertically lower side will be simply referred to as “lower side”. An X axis direction is a direction orthogonal to the Z axis direction and is a front-rear direction of a vehicle mounted with the drive device. In embodiment below, a +X side is a front side of a vehicle, and a −X side is a rear side of the vehicle. A Y axis direction is a direction orthogonal to both the X axis direction and the Z axis direction, and is a left-right direction of a vehicle, that is, a vehicle width direction. In embodiment below, a +Y side is a left side of a vehicle, and a −Y side is a right side of a vehicle. The front-rear direction and the left-right direction are a horizontal direction orthogonal to the vertical direction.

Note that a positional relationship in the front-rear direction is not limited to a positional relationship in an embodiment below, and the +X side may be the rear side of a vehicle and the −X side may be the front side of a vehicle. In this case, the +Y side is the right side of a vehicle, and the −Y side is the left side of a vehicle. Further, in the present description, a “parallel direction” includes a substantially parallel direction, and an “orthogonal direction” includes a substantially orthogonal direction.

A central axis J illustrated in the drawings as appropriate is a virtual axis extending in a direction intersecting the vertical direction. More specifically, the central axis J extends in the Y axis direction orthogonal to the vertical direction, that is, the left-right direction of a vehicle. In description below, unless otherwise stated, a direction parallel to the central axis J is simply referred to as “axial direction”, a radial direction about the central axis J is simply referred to as “radial direction”, and a circumferential direction about the central axis J, that is, a direction about the central axis J is simply referred to as “circumferential direction”. In an embodiment below, the left side (+Y side) is referred to as “one side in the axial direction”, and the right side (−Y side) is referred to as “the other side in the axial direction”.

An arrow 0 illustrated in the drawings as appropriate indicates a circumferential direction. In description below, a side advancing clockwise about the central axis J as viewed from the right side (−Y side) in the circumferential direction, that is, a side (+θ side) on which the arrow e faces is referred to as “one side in the circumferential direction”, and a side advancing counterclockwise about the central axis J as viewed from the right side in the circumferential direction, that is, a side (−θ side) opposite to the side that the arrow θ faces is referred to as “another side in the circumferential direction”.

### First Embodiment

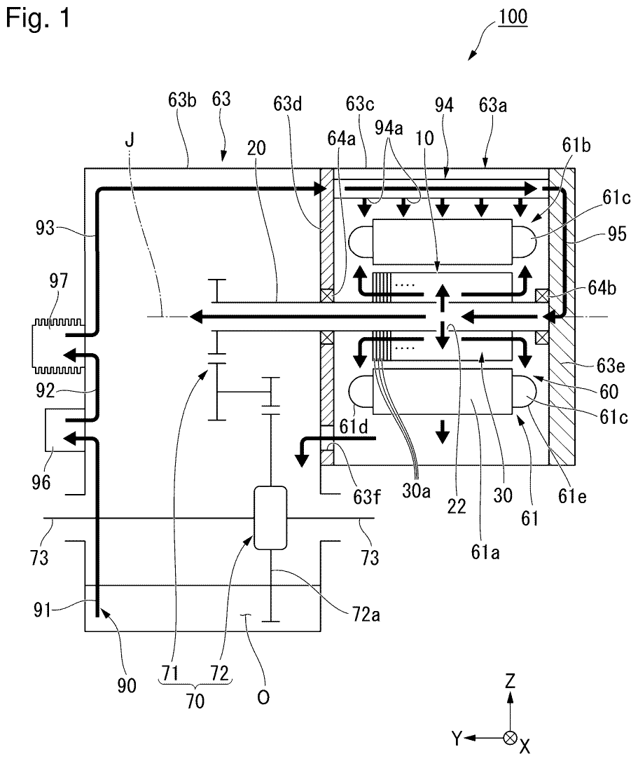

A drive device 100 of the present embodiment illustrated in FIG. 1 is a drive device that is mounted on a vehicle and rotates an axle 73. A vehicle in which the drive device 100 is mounted is a vehicle including a motor as a power source, such as a hybrid vehicle (HEV), a plug-in hybrid vehicle (PHV), or an electric vehicle (EV). As illustrated in FIG. 1, the drive device 100 includes a rotating electric machine 60, a gear mechanism 70 connected to the rotating electric machine 60, and a housing 63 accommodating the rotating electric machine 60 and the gear mechanism 70 in the inside. In the present embodiment, the rotating electric machine 60 is a motor.

The housing 63 accommodates the rotating electric machine 60 and the gear mechanism 70 in the inside. The housing 63 includes a motor housing 63a that accommodates the rotating electric machine 60 in the inside and a gear housing 63b that accommodates the gear mechanism 70 in the inside. The motor housing 63a is connected to the other side in the axial direction (−Y side) of the gear housing 63b. The motor housing 63a has a peripheral wall portion 63c, a partition wall portion 63d, and a lid portion 63e. The peripheral wall portion 63c and the partition wall portion 63d are a part of an identical single member, for example. The lid portion 63e is, for example, a separate body from the peripheral wall portion 63c and the partition wall portion 63d.

The peripheral wall portion 63c has a tubular shape that surrounds the central axis J and opens to the other side in the axial direction (−Y side). The partition wall portion 63d is connected to an end on the one side in the axial direction (+Y side) of the peripheral wall portion 63c. The partition wall portion 63d separates the inside of the motor housing 63a and the inside of the gear housing 63b in the axial direction. The partition wall portion 63d has a partition wall opening 63f that connects the inside of the motor housing 63a and the inside of the gear housing 63b. A bearing 64a is held by the partition wall portion 63d. The lid portion 63e is fixed to an end portion on the other side in the axial direction of the peripheral wall portion 63c. The lid portion 63e closes an opening on the other side in the axial direction of the peripheral wall portion 63c. A bearing 64b is held by the lid portion 63e.

The gear housing 63b accommodates oil O in the inside. The oil O is stored in a lower region in the gear housing 63b. The oil O is circulated through a flow path 90, which will be described below. The oil O is used as a refrigerant for cooling the rotating electric machine 60. The oil O is used as lubricating oil for the gear mechanism 70. As the oil O, it is preferable to use oil equivalent to an automatic transmission fluid (ATF) having relatively low viscosity in order to achieve a function of a refrigerant and lubricating oil, for example.

The gear mechanism 70 is connected to the rotating electric machine 60 and transmits rotation of a rotor 10 described later to the axle 73 of a vehicle. The gear mechanism 70 of the present embodiment includes a reduction gear 71 connected to the rotating electric machine 60 and a differential gear 72 connected to the reduction gear 71. The differential gear 72 includes a ring gear 72a. To the ring gear 72a, torque output from the rotating electric machine 60 is transmitted via the reduction gear 71. An end portion of the lower side of the ring gear 72a is immersed in the oil O stored in the gear housing 63b. Rotation of the ring gear 72a scoops up the oil O. The oil O that is scooped up is supplied as lubricating oil to, for example, the reduction gear 71 and the differential gear 72.

The rotating electric machine 60 includes the rotor 10 rotatable about the central axis J, and a stator 61 facing the rotor 10 with a gap in the radial direction interposed between them. In the present embodiment, the stator 61 is located on the outer side in the radial direction of the rotor 10. The stator 61 includes a stator core 61a and a coil assembly 61b attached to the stator core 61a. The coil assembly 61b includes a plurality of coils 61c attached to the stator core 61a. Although not illustrated, the coil assembly 61b may include a binding member or the like to bind the coils 61c together, and may include an interconnecting wire for connecting the coils 61c to one another. The coil assembly 61b has coil ends 61d and 61e protruding in the axial direction more than the stator core 61a.

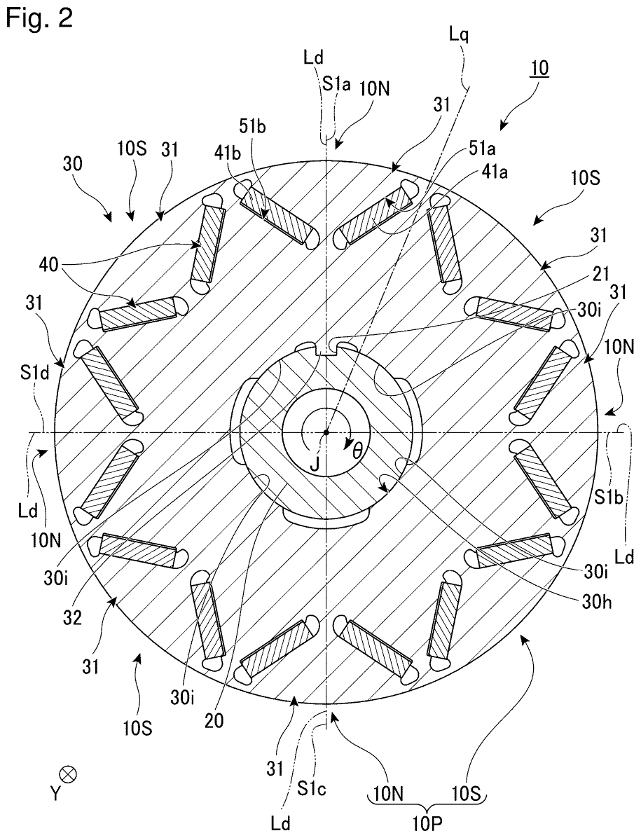

As illustrated in FIG. 2, the rotor 10 includes a shaft 20, a rotor core 30, and a plurality of magnets 40. As illustrated in FIG. 1, the shaft 20 extends in the axial direction around the central axis J. An end portion on the one side in the axial direction (+Y side) of the shaft 20 protrudes into the gear housing 63b. As illustrated in FIG. 2, in the present embodiment, the shaft 20 is a cylindrical hollow shaft around the central axis J. The shaft 20 has a groove portion 21 recessed to the inner side in the radial direction from an outer peripheral surface of the shaft 20. Although not illustrated, the groove portion 21 extends in the axial direction. In the present embodiment, one of the groove portion 21 is provided. As illustrated in FIG. 1, the shaft 20 is provided with a hole portion 22 that connects the inside of the shaft 20 and the outside of the shaft 20. A plurality of the hole portions 22 are provided at intervals in the circumferential direction.

As illustrated in FIG. 2, the rotor core 30 is fixed to an outer peripheral surface of the shaft 20. The rotor core 30 has a substantially cylindrical shape around the central axis J. The rotor core 30 has a through hole 30h that penetrates the rotor core 30 in the axial direction. The central axis J passes through the through hole 30h. In the present embodiment, the through hole 30h is a substantially circular hole around the central axis J. The shaft 20 passes through the through hole 30h in the axial direction. An inner peripheral surface of the through hole 30h is fixed to an outer peripheral surface of the shaft 20. For example, the shaft 20 is press-fitted into the through hole 30h.

A radially inner surface of the through hole 30h has a support surface 30i. The support surface 30i is a surface extending in an arc shape around the central axis J when viewed in the axial direction. A plurality of the support surfaces 30i are provided at intervals in the circumferential direction. In the present embodiment, four of the support surfaces 30i are provided. A plurality of the support surfaces 30i are arranged on the same circle around the central axis J when viewed in the axial direction. A plurality of the support surfaces 30i are in contact with an outer peripheral surface of the shaft 20.

The rotor core 30 is made from a magnetic body. As illustrated in FIG. 1, the rotor core 30 includes a plurality of plate members 30a laminated in the axial direction. The plate member 30a is a plate-like member whose plate surface faces the axial direction. The plate member 30a has a substantially disk shape centered on the central axis J. A material of the plate member 30a is a rolled steel material formed by rolling in a predetermined direction. For example, a material of the plate member 30a is an electromagnetic steel plate.

The plate members 30a are laminated in a state of being rotated in the circumferential direction at a predetermined angle one or multiple at a time. That is, in the present embodiment, a plurality of the plate members 30a are rotated and laminated. In the present embodiment, a predetermined angle at which the plate member 30a is rotated and laminated is 90°. By rotating and laminating a plurality of the plate members 30a in this manner, a plurality of the plate members 30a include two or more of the plate members 30a whose rolling directions are different from each other. A rolling direction of the plate member 30a is a direction in which a rolled steel material which is a material of the plate member 30a is rolled.

Although not illustrated, the rotor core 30 has a plurality of core piece portions arranged in the axial direction. Each of the core piece portions is configured by laminating a plurality of the plate members 30a in the axial direction. Although not illustrated, a substantially disk-shaped plate is provided between at least one set of core piece portions adjacent to each other in the axial direction.

As illustrated in FIG. 2, the rotor core 30 includes a plurality of magnet holding portions 31 arranged side by side in the circumferential direction. A plurality of the magnet holding portions 31 are provided in an outer portion in the radial direction of the rotor core 30. A plurality of the magnet holding portions 31 are arranged at equal intervals over the entire circumference along the circumferential direction. In the present embodiment, eight of the magnet holding portions 31 are provided.

A plurality of the magnet holding portions 31 have a pair of first magnet holes 51a and 51b adjacent to each other in the circumferential direction. That is, the rotor core 30 has a pair of the first magnet holes 51a and 51b. As described above, in the present embodiment, a total of two magnet holes, which are a pair of the first magnet holes 51a and 51b, are provided in each of the magnet holding portions 31. In the present embodiment, a pair of the first magnet holes 51a and 51b penetrate the rotor core 30 in the axial direction. Note that a pair of the first magnet holes 51a and 51b may be holes having a bottom portion at an end portion in the axial direction.

One of the magnets 40 is arranged in two magnet holes in each of the magnet holding portions 31. A type of the magnet 40 is not particularly limited. The magnet 40 may be, for example, a neodymium magnet or a ferrite magnet. The magnet 40 has, for example, a rectangular parallelepiped shape elongated in the axial direction. The magnet 40 extends, for example, from one end portion in the axial direction to another end portion in the axial direction of the rotor core 30.

A plurality of the magnets 40 include a pair of first magnets 41a and 41b arranged in a pair of the first magnet holes 51a and 51b, respectively. Each of the magnets 40 is fixed in each magnet hole. A method of fixing each of the magnets 40 into each magnet hole is not particularly limited. For example, each magnet may be fixed into each magnet hole by crimping a part of the rotor core 30, may be fixed in each magnet hole by resin filled in a portion other than a portion where the magnet 40 is arranged in each magnet hole, or may be fixed in each magnet hole by a foam sheet arranged in a portion other than a portion where the magnet 40 is arranged in each magnet hole.

One of the magnet holding portions 31 and a plurality of the magnets 40 arranged in a plurality of magnet holes provided in one of the magnet holding portions 31 constitute a magnetic pole portion 10P. A plurality of the magnetic pole portions 10P are arranged at equal intervals over the entire circumference along the circumferential direction. That is, the rotor 10 includes a plurality of the magnetic pole portions 10P arranged at intervals in the circumferential direction. In the present embodiment, eight of the magnetic pole portions 10P are provided. A plurality of the magnetic pole portions 10P include a plurality of magnetic pole portions 10N in which a magnetic pole on an outer peripheral surface of the rotor core 30 is an N pole and a plurality of magnetic pole portions 10S in which a magnetic pole on an outer peripheral surface of the rotor core 30 is an S pole. In the present embodiment, four of the magnetic pole portions 10N and four of the magnetic pole portions 10S are provided. Four of the magnetic pole portions 10N and four of the magnetic pole portions 10S are alternately arranged along the circumferential direction. Configurations of the magnetic pole portions 10P are similar to one another except that magnetic poles on an outer peripheral surface of the rotor core 30 are different and circumferential positions are different.

In the magnetic pole portion 10P, the first magnet hole 51a and the first magnet hole 51b are arranged with a magnetic pole center line Ld interposed between them in the circumferential direction. The magnetic pole center line Ld is a virtual line that passes through the center in the circumferential direction between a pair of the first magnet holes 51a and 51b and extends in the radial direction. The magnetic pole center line Ld passes through the center in the circumferential direction of the magnetic pole portion 10P. The center in the circumferential direction of the magnetic pole portion 10P is the center in the circumferential direction of the magnet holding portion 31. The magnetic pole center line Ld is provided for each of the magnetic pole portions 10P. The magnetic pole center line Ld passes on a d axis of the rotor 10 when viewed in the axial direction. A direction in which the magnetic pole center line Ld extends is the d axis direction of the rotor 10. The first magnet hole 51a and the first magnet hole 51b are arranged in line symmetry with the magnetic pole center line Ld as a symmetry axis when viewed in the axial direction.

A pair of the first magnet holes 51a and 51b extend in directions away from each other in the circumferential direction toward the outer side in the radial direction from the inner side in the radial direction when viewed in the axial direction. That is, a distance in the circumferential direction between the first magnet hole 51a and the first magnet hole 51b increases toward the outer side in the radial direction from the inner side in the radial direction. A pair of the first magnet holes 51a and 51b are arranged along a V shape expanding in the circumferential direction toward the outer side in the radial direction when viewed in the axial direction. A pair of the first magnets 41a and 41b arranged in a pair of the first magnet holes 51a and 51b are arranged along a V shape expanding in the circumferential direction toward the outer side in the radial direction when viewed in the axial direction.

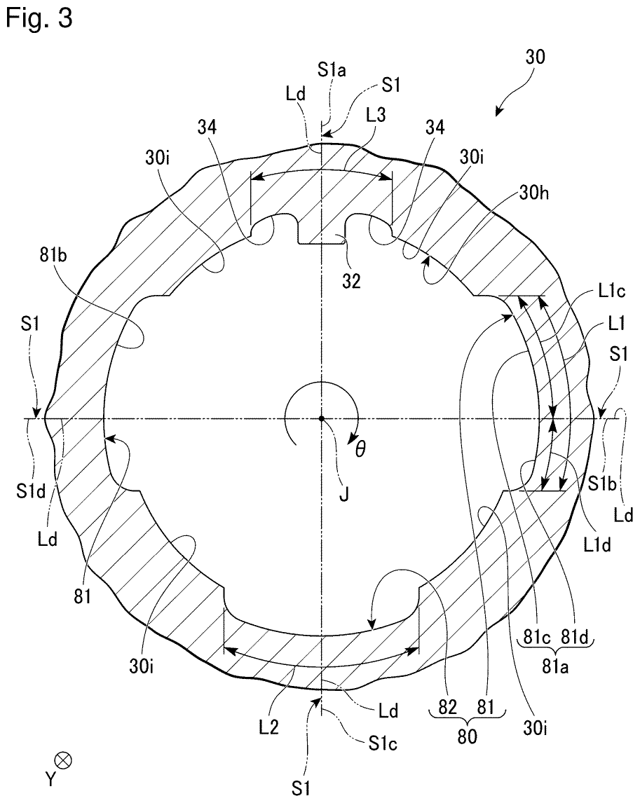

As illustrated in FIG. 3, the rotor core 30 has a projecting portion 32 provided at a radially inner edge portion of the through hole 30h. The projecting portion 32 protrudes to the inner side in the radial direction. An end portion on the inner side in the radial direction of the projecting portion 32 is located further on the inner side in the radial direction than the support surface 30i. Although not illustrated, the projecting portion 32 extends in the axial direction. In the present embodiment, only one projecting portion 32 is provided at a radially inner edge portion of the through hole 30h. The projecting portion 32 has a substantially rectangular shape when viewed in the axial direction. A surface on the inner side in the radial direction of the projecting portion 32 is orthogonal to the radial direction. The projecting portion 32 is arranged at a position overlapping the magnetic pole center line Ld that passes through the center in the circumferential direction of the magnetic pole portion 10P and extends in the radial direction when viewed in the axial direction. For this reason, strength of a portion located on the inner side in the radial direction of the magnet 40 in the magnetic pole portion 10P in the rotor core 30 can be improved by the projecting portion 32. By the above, the magnet 40 can be more stably held in the magnetic pole portion 10P. In the present embodiment, the center in the circumferential direction of the projecting portion 32 overlaps the magnetic pole center line Ld in one of the magnetic pole portions 10P when viewed in the axial direction.

As illustrated in FIG. 2, the projecting portion 32 is fitted into the groove portion 21. By the above, the shaft 20 and the rotor core 30 are caught with each other in the circumferential direction, and relative rotation of the shaft 20 and the rotor core 30 in the circumferential direction is suppressed.

As illustrated in FIG. 3, depressed portions 34 are provided on both sides in the circumferential direction of the projecting portion 32. A pair of the depressed portions 34 are provided at a radially inner edge portion of the through hole 30h and recessed to the outer side in the radial direction. A pair of the depressed portions 34 are recessed to the outer side in the radial direction from the support surface 30i. In the present embodiment, when viewed in the axial direction, an inner edge of a pair of the depressed portions 34 has a curved shape that curves in a direction projecting to the outer side in the radial direction. A pair of the depressed portions 34 sandwich the projecting portion 32 in the circumferential direction and are arranged adjacent to the projecting portion 32.

By providing a pair of the depressed portions 34 as described above, a part of stress generated in the shaft 20 when the shaft 20 is press-fitted into the through hole 30h can be released in a portion facing a pair of the depressed portions 34 in the shaft 20 in the radial direction. Therefore, the shaft 20 can be easily press-fitted into the through hole 30h. Further, by arranging a pair of the depressed portions 34 adjacent to both sides in the circumferential direction of the projecting portion 32, an inner edge portion of the through hole 30h to which an end portion on the outer side in the radial direction of the projecting portion 32 is connected can be set as an inner edge of the depressed portion 34. By the above, by forming a shape of an inner edge of the depressed portion 34 when viewed in the axial direction into a curved shape, it is easy to smoothly connect an end portion on the outer side in the radial direction of the projecting portion 32 to an inner edge of the through hole 30h. Therefore, stress generated in the projecting portion 32 is likely to be dispersed and received at a connection portion between an end portion on the outer side in the radial direction of the projecting portion 32 and an inner edge of the depressed portion 34.

The rotor core 30 has a plurality of recessed portions 80 provided at intervals in the circumferential direction at a radially inner edge portion of the through hole 30h. A plurality of the recessed portions 80 are recessed to the outer side in the radial direction. In the present embodiment, a plurality of the recessed portions 80 are recessed to the outer side in the radial direction from the support surface 30i. In the present embodiment, the support surface 30i is provided between the recessed portions 80 adjacent to each other in the circumferential direction and between the recessed portion 80 and the depressed portion 34 in the circumferential direction at a radially inner edge portion of the through hole 30h. A plurality of the recessed portions 80 are provided, for example, over the entire rotor core 30 in the axial direction. Note that a plurality of the recessed portions 80 may be provided only in a part in the axial direction of the rotor core 30.

A plurality of the recessed portions 80 have a substantially arc shape extending in the circumferential direction when viewed in the axial direction. In the present embodiment, a plurality of the recessed portions 80 have the same shape when viewed in the axial direction. Therefore, for example, in a case where a part of a laminated body 130 described later is scraped off with a mold or the like to form the recessed portion 80, a plurality of the recessed portions 80 can be formed by one type of mold. By the above, it is not necessary to prepare a plurality of types of molds to form a plurality of the recessed portions 80, and manufacturing cost of the rotor 10 can be reduced.

Note that, in the present description, “certain two recessed portions have the same shape when viewed in the axial direction” means that shapes of certain two recessed portions when viewed in the axial direction only need to be the same as each other, and sizes of certain two recessed portions when viewed in the axial direction may be different from each other.

The “size of recessed portions when viewed in the axial direction” is an area inside the recessed portion in a cross section orthogonal to the axial direction. The “area inside the recessed portion in a cross section orthogonal to the axial direction” is an area of a region surrounded by an outer peripheral surface of a shaft and an inner edge of the recessed portion in the cross section orthogonal to the axial direction.

In the present embodiment, sizes of a plurality of the recessed portions 80 are the same as each other when viewed in the axial direction. In other words, in a cross section orthogonal to the axial direction, an area of a region surrounded by an outer peripheral surface of the shaft 20 and an inner edge of each of the recessed portions 80 is the same.

A plurality of the recessed portions 80 include a first recessed portion 81 and a second recessed portion 82. In the present embodiment, a total of three of the recessed portions 80 including two of the first recessed portions 81 and one of the second recessed portion 82 are provided. Two of the first recessed portions 81 include a first recessed portion 81a and a first recessed portion 81b. Two of the first recessed portions 81a and 81b are arranged with one of the second recessed portion 82 interposed between them in the circumferential direction. The second recessed portion 82 is located on the opposite side of the projecting portion 32 across the central axis J in the radial direction. That is, a plurality of the recessed portions 80 include the recessed portion 80 arranged on the opposite side to the projecting portion 32 across the central axis J in the radial direction, and the recessed portion 80 is the second recessed portion 82.

In the present embodiment, when viewed in the axial direction, a plurality of virtual lines S1 extending to the outer side in the radial direction from the central axis J, arranged at equal intervals in the circumferential direction, and as many as the total number of the number of the projecting portions 32 and the number of the recessed portions 80 are defined. In the present embodiment, the number of the projecting portions 32 is one, and the number of the recessed portions 80 is three. The total number of the projecting portions 32 and the recessed portions 80 is four. Therefore, in the present embodiment, a total of four of the virtual lines S1 including a virtual line S1a, a virtual line S1b, a virtual line S1c, and a virtual line S1d are provided. Four of the virtual lines S1a, S1b, S1c, and S1d are arranged at equal intervals at intervals of 90° in the circumferential direction. The virtual line S1a is the virtual line S1 overlapping the center in the circumferential direction of the projecting portion 32 when viewed in the axial direction. In the present embodiment, the virtual line S1a is arranged at a position overlapping the magnetic pole center line Ld overlapping the projecting portion 32 when viewed in the axial direction.

The virtual line S1b is arranged adjacent to the one side in the circumferential direction (+θ side) of the virtual line S1a at an interval of 90°. The virtual line S1c is arranged adjacent to the one side in the circumferential direction of the virtual line S1b at an interval of 90°. The virtual line S1d is arranged adjacent to the one side in the circumferential direction of the virtual line S1c at an interval of 90°. The virtual line S1a and the virtual line S1c are arranged on the same straight line when viewed in the axial direction. The virtual line S1b and the virtual line S1d are arranged on the same straight line when viewed in the axial direction. The virtual lines S1a and S1c and the virtual lines S1b and S1d extend in directions orthogonal to each other. The virtual lines S1b, S1c, and S1d are also arranged at positions overlapping the magnetic pole center line Ld in the magnetic pole portions 10P different from each other when viewed in the axial direction.

In the present embodiment, each of the virtual lines S1b, S1c, and S1d overlaps each of a plurality of the recessed portions 80 when viewed in the axial direction. The virtual line S1b overlaps the first recessed portion 81a when viewed in the axial direction. The virtual line S1c overlaps the second recessed portion 82 when viewed in the axial direction. The virtual line S1d overlaps the first recessed portion 81b when viewed in the axial direction. That is, the first recessed portion 81 and the second recessed portion 82 overlap the virtual line S1 when viewed in the axial direction. The virtual line S1 closest to the first recessed portion 81a in the circumferential direction is the virtual line S1b. The virtual line S1 closest to the first recessed portion 81b in the circumferential direction is the virtual line S1d. The virtual line S1 closest to the second recessed portion 82 in the circumferential direction is the virtual line S1c.

The second recessed portion 82 extends in the circumferential direction when viewed in the axial direction. When viewed in the axial direction, an inner edge of the second recessed portion 82 has a curved shape that is curved in a direction projecting to the outer side in the radial direction. The center in the circumferential direction of the second recessed portion 82 overlaps the virtual line S1c when viewed in the axial direction. The second recessed portion 82 has a line-symmetrical shape with the virtual line S1c passing through the second recessed portion 82 when viewed in the axial direction as a symmetry axis.

The first recessed portions 81a and 81b extend in the circumferential direction when viewed in the axial direction. When viewed in the axial direction, inner edges of the first recessed portions 81a and 81b are curved in a direction projecting to the outer side in the radial direction. When viewed in the axial direction, a shape of the first recessed portions 81a and 81b is the same as a shape of the second recessed portion 82. When viewed in the axial direction, a dimension L1 in the circumferential direction of the first recessed portions 81a and 81b is the same as a dimension L2 in the circumferential direction of the second recessed portion 82. Each of the dimensions L1 and L2 is equal to or larger than a dimension L3 in the circumferential direction of a portion including the projecting portion 32 and a pair of the depressed portions 34. In the present embodiment, each of the dimensions L1 and L2 is larger than the dimension L3 in the circumferential direction of a portion including the projecting portion 32 and a pair of the depressed portions 34.

Space volume inside the first recessed portion 81 is the same as space volume inside the second recessed portion 82. Note that, in the present description, “space volume inside the recessed portion” is volume of a space surrounded by an outer peripheral surface of a shaft and an inner surface of the recessed portion. In the present embodiment, space volume inside the first recessed portion 81 is volume of a space surrounded by an outer peripheral surface of the shaft 20 and an inner surface of the first recessed portion 81. Space volume inside the second recessed portion 82 is volume of a space surrounded by an outer peripheral surface of the shaft 20 and an inner surface of the second recessed portion 82.

The first recessed portion 81a and the first recessed portion 81b are arranged with the central axis J interposed between them in the radial direction. The first recessed portion 81a is arranged at an interval on one side in the circumferential direction (+θ side) of the projecting portion 32. The first recessed portion 81b is arranged at an interval on the other side in the circumferential direction (−θ side) of the projecting portion 32. The first recessed portion 81a and the first recessed portion 81b are arranged with the projecting portion 32 and a pair of the depressed portions 34 interposed between them in the circumferential direction. In the present embodiment, the first recessed portion 81a and the first recessed portion 81b are arranged in line symmetry with the virtual lines S1a and S1c as symmetry axes when viewed in the axial direction. For this reason, in description below, description of the first recessed portion 81b may be omitted for the same configuration except that the first recessed portion 81b is arranged line-symmetrically with the first recessed portion 81a.

The center in the circumferential direction of the first recessed portion 81a is arranged to be displaced to the other side in the circumferential direction (−θ side) with respect to the virtual line S1b. The center in the circumferential direction of the first recessed portion 81b is arranged to be displaced to the one side in the circumferential direction (+θ side) with respect to the virtual line S1d. That is, the first recessed portions 81a and 81b satisfy that an arrangement relationship in the circumferential direction with respect to the virtual lines S1b and S1d closest to the first recessed portions 81a and 81b in the circumferential direction when viewed in the axial direction is different from an arrangement relationship in the circumferential direction of the second recessed portion 82 with respect to the virtual line S1c overlapping the second recessed portion 82. For this reason, as compared with a case where an arrangement relationship in the circumferential direction of the first recessed portions 81a and 81b with respect to the virtual lines S1b and S1d is the same as an arrangement relationship in the circumferential direction of the second recessed portion 82 with respect to the virtual line S1c, the first recessed portions 81a and 81b can be easily arranged at positions that offset a weight balance change in the circumferential direction of the rotor 10 due to provision of the projecting portion 32. By the above, also when only one projecting portion 32 is provided at a radially inner edge portion of the through hole 30h, it is possible to suppress displacement of the center of gravity of the rotor 10 with respect to the central axis J. Therefore, when the rotor 10 rotates, vibration of the rotor 10 can be suppressed, and generation of noise can be suppressed. Further, since the number of the groove portions 21 to which the projecting portion 32 is fitted can be set to one, it is possible to suppress increase in manufacturing cost of the shaft 20.

Note that, in the present embodiment, the “case where an arrangement relationship in the circumferential direction of the first recessed portions 81a and 81b with respect to the virtual lines S1b and S1d is the same as an arrangement relationship in the circumferential direction of the second recessed portion 82 with respect to the virtual line S1c” is a case where the centers in the circumferential direction of the first recessed portions 81a and 81b overlap the virtual lines S1b and S1d similarly to the second recessed portion 82 when viewed in the axial direction. In the present embodiment, if the first recessed portions 81a and 81b are arranged in this manner, weight of a portion located further on the side where the projecting portion 32 is provided than the virtual lines S1b and S1d in the rotor core 30 becomes larger than weight of a portion located further on the side where the second recessed portion 82 is provided than the virtual lines S1b and S1d in the rotor core 30, and the center of gravity of the rotor 10 is displaced to the side closer to the projecting portion 32 with respect to the central axis J.

In the present embodiment, the first recessed portions 81a and 81b have asymmetric shapes across the virtual lines S1b and S1d passing through the first recessed portions 81a and 81b when viewed in the axial direction. For this reason, it is easy to suitably vary a weight change due to provision of the first recessed portions 81a and 81b between a portion on the one side in the circumferential direction and a portion on the other side in the circumferential direction with the virtual lines S1b and S1d interposed between them in the rotor core 30. By the above, for example, space volume inside a portion on the side closer to the projecting portion 32 in the circumferential direction than the virtual lines S1b and S1d in the first recessed portions 81a and 81b is made larger than space volume inside a portion on the side farther from the projecting portion 32 in the circumferential direction than the virtual lines S1b and S1d in the first recessed portions 81a and 81b, so that it is possible to more easily offset a weight balance change in the circumferential direction of the rotor core 30 due to provision of the projecting portion 32. Therefore, it is possible to further suppress displacement of the center of gravity of the rotor 10 with respect to the central axis J.

Note that, in the present description, that “recessed portion has an asymmetric shape across a virtual line” only needs to mean that, when viewed in the axial direction, a shape of a portion located further on the one side in the circumferential direction than the virtual line in the recessed portion and a shape of a portion located further on the other side in the circumferential direction than the virtual line in the recessed portion are not shapes that are line-symmetric with each other with the virtual line as a symmetry axis.

The first recessed portion 81a has a first portion 81c and a second portion 81d. The first portion 81c is a portion located on the side (−θ side) closer to the projecting portion 32 in the circumferential direction than the virtual line S1b in the first recessed portion 81a. The second portion 81d is a portion located on the side (+θ side) farther from the projecting portion 32 in the circumferential direction than the virtual line S1b in the first recessed portion 81a. A dimension L1c in the circumferential direction of the first portion 81c is larger than a dimension L1d in the circumferential direction of the second portion 81d. That is, when viewed in the axial direction, the dimension L1c in the circumferential direction of the first portion 81c closer to the projecting portion 32 in the circumferential direction than the virtual line S1b in the first recessed portion 81a is larger than the dimension L1d in the circumferential direction of the second portion 81d farther from the projecting portion 32 in the circumferential direction than the virtual line S1b in the first recessed portion 81a. For this reason, by providing the first portion 81c, weight of a portion close to the projecting portion 32 in the circumferential direction in the rotor core 30 can be easily reduced. By the above, weight of a portion close to the projecting portion 32, which is increased by provision of the projecting portion 32, can be suitably reduced by the first portion 81c. Therefore, it is possible to more suitably prevent the weight balance in the circumferential direction of the rotor 10 from being lost, and it is possible to more suitably suppress displacement of the center of gravity of the rotor 10 with respect to the central axis J.

When viewed in the axial direction, a dimension in the circumferential direction of a portion closer to the projecting portion 32 in the circumferential direction than the virtual line S1d in the first recessed portion 81b is larger than a dimension in the circumferential direction of a portion farther from the projecting portion 32 in the circumferential direction than the virtual line S1d in the first recessed portion 81b. A portion closer to the projecting portion 32 in the circumferential direction than the virtual line S1d in the first recessed portion 81b is a portion located further on the one side in the circumferential direction (+θ side) than the virtual line S1d in the first recessed portion 81b. A portion farther from the projecting portion 32 in the circumferential direction than the virtual line S1d in the first recessed portion 81b is a portion located further on the other side in the circumferential direction (−θ side) than the virtual line S1d in the first recessed portion 81b.

In the present embodiment, the first recessed portion 81 is arranged at a position closer to the projecting portion 32 in the circumferential direction than the second recessed portion 82. For this reason, by making an arrangement relationship in the circumferential direction of the first recessed portion 81 with respect to the virtual lines S1b and S1d different from an arrangement relationship in the circumferential direction of the second recessed portion 82 with respect to the virtual line S1c, weight of a portion close to the projecting portion 32 in the rotor core 30 can be more easily changed. By the above, a weight change of a part of the rotor core 30 caused by provision of the projecting portion 32 can be more easily offset by providing the first recessed portion 81. Therefore, the weight balance in the circumferential direction of the rotor 10 can be further prevented from being lost, and the center of gravity of the rotor 10 can be further prevented from being displaced with respect to the central axis J.

In the present embodiment, among a plurality of the recessed portions 80, the recessed portion 80 arranged adjacent to the projecting portion 32 in the circumferential direction is the first recessed portion 81. For this reason, by making an arrangement relationship in the circumferential direction of the first recessed portion 81 with respect to the virtual lines S1b and S1d different from an arrangement relationship in the circumferential direction of the second recessed portion 82 with respect to the virtual line S1c, weight of a portion close to the projecting portion 32 in the rotor core 30 can be more suitably and easily changed. By the above, a weight change of a part of the rotor core 30 caused by provision of the projecting portion 32 can be more suitably and easily offset by providing the first recessed portion 81. Therefore, it is possible to more suitably prevent the balance in the circumferential direction of the rotor 10 from being lost, and it is possible to more suitably prevent the center of gravity of the rotor 10 from being displaced with respect to the central axis J.

As described above, in the present embodiment, the second recessed portion 82 has a line-symmetric shape with the virtual line S1c passing through the second recessed portion 82 as a symmetry axis when viewed in the axial direction. For this reason, even if the second recessed portion 82 is provided, the weight balance in the circumferential direction of the rotor core 30 can be hardly lost. Further, in the present embodiment, the recessed portion 80 arranged opposite to the projecting portion 32 across the central axis J in the radial direction is the second recessed portion 82. Therefore, it is possible to reduce weight of a portion of the rotor core 30 located on the side opposite to the projecting portion 32 in the radial direction by providing the second recessed portion 82 while suppressing occurrence of the weight imbalance of the rotor core 30 due to provision of the second recessed portion 82 on both sides across the virtual line S1c in the circumferential direction. By the above, it is possible to prevent the weight balance in the circumferential direction of the rotor 10 from being lost more, and it is possible to more suitably suppress displacement of the center of gravity of the rotor 10 with respect to the central axis J.

As described above, in the present embodiment, while the recessed portions 80 have the same configuration except that positions in the circumferential direction are different, a part of the recessed portions 80, that is, the first recessed portion 81 is arranged to be biased close to the projecting portion 32 in the circumferential direction, so that a weight balance change in the circumferential direction of the rotor 10 due to provision of the projecting portion 32 is offset.

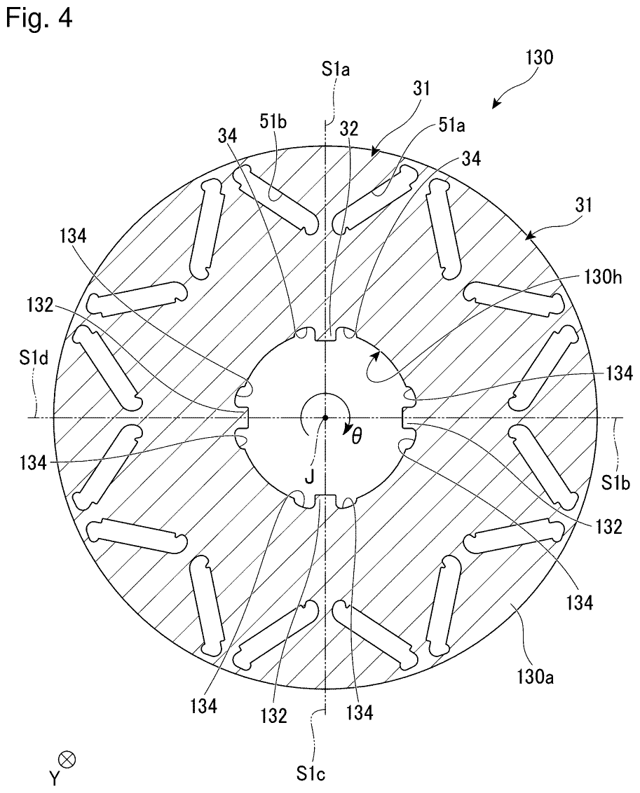

In the present embodiment, the recessed portion 80 is formed by scraping off a projecting portion 132 and a pair of depressed portions 134 in the laminated body 130 illustrated in FIG. 4 by press working or the like using a mold. The laminated body 130 illustrated in FIG. 4 is configured by laminating a plurality of plate members 130a in the axial direction. The plate member 130a has the same configuration as the plate member 30a except that a part of the recessed portion 80 is not provided. A plurality of the plate members 130a have the same shape.

In addition to the projecting portion 32, three of the projecting portions 132 are provided at a radially inner edge portion of a through hole 130h of the laminated body 130. Three of the projecting portions 132 are arranged at positions overlapping with the virtual lines S1b, S1c, and S1d when viewed in the axial direction. When viewed in the axial direction, the centers in the circumferential direction of three of the projecting portions 132 overlap with the virtual lines S1b, S1c, and S1d. A shape of three of the projecting portions 132 is similar to a shape of the projecting portion 32. The projecting portion 132 has the same configuration as the projecting portion 32 except that a position in the circumferential direction is different.

An arrangement relationship in the circumferential direction of the projecting portions 132 with respect to the virtual lines S1b, S1c, and S1d is the same as an arrangement relationship in the circumferential direction of the projecting portion 32 with respect to the virtual line S1a. Four of the projecting portions 32 and 132 are arranged at equal intervals at intervals of 90° in the circumferential direction. A pair of the depressed portions 134 located on both sides in the circumferential direction of each of the projecting portions 132 is provided in a radially inner edge portion of the through hole 130h. A pair of the depressed portions 134 have the same configuration as a pair of the depressed portions 34 except that a pair of the depressed portions 134 are provided with respect to the projecting portion 132.

The through hole 130h has the same configuration as the through hole 30h except that the projecting portion 132 and the depressed portion 134 are provided instead of the recessed portion 80 in a radially inner edge portion. The laminated body 130 has the same configuration as the rotor core 30 except that the projecting portion 132 and the depressed portion 134 are provided instead of the recessed portion 80 at a radially inner edge portion of the through hole 130h.

A worker or the like who manufactures the rotor core 30 punches and scrapes off a portion where each of projecting portions 132 and each pair of the depressed portions 134 are provided in the laminated body 130 with a mold in the axial direction, and forms the recessed portion 80 in each portion where each of the projecting portions 132 and each pair of the depressed portions 134 are provided. By the above, the rotor core 30 having the recessed portion 80 is formed.

Note that in the present description, the “worker or the like” includes a worker who performs each piece of work and an assembly device. Each piece of work may be performed only by a worker, may be performed only by an assembly device, or may be performed by a worker and an assembly device.

As described above, a plurality of the plate members 30a constituting the rotor core 30 are rotated and laminated at a predetermined angle. That is, a plurality of the plate members 130a constituting the laminated body 130 are also rotated and laminated at a predetermined angle. In the present embodiment, every time one or a plurality of the plate members 130a are laminated, a worker or the like who laminates the plate members 130a rotates and laminates the one or plurality of the plate members 130a by rotating and laminating the one or plurality of plate members 130a about the central axis J by 90° with respect to the plate member 130a previously laminated. The plate member 130a has a shape with an N-fold rotational symmetry about the central axis J. When a predetermined angle at which the plate member 130a is rotated and laminated is φ, N=360[°]/φ is satisfied. That is, in the present embodiment, the plate member 130a has a four-fold rotational symmetry about the central axis J. For this reason, a plurality of the plate members 130a can be rotated and laminated at the predetermined angle φ while shapes of a plurality of the plate members 130a are the same, so that the laminated body 130 having the projecting portions 32 and 132 and the depressed portions 34 and 134.

In a case where the laminated body 130 is formed as described above, one projecting portion 32 is formed and (N−1) of the projecting portions 132 are formed. Since the recessed portion 80 is formed in each portion where the projecting portion 132 is provided in the laminated body 130, the number of the recessed portions 80 provided in the rotor core 30 is also (N−1). That is, the total number of the number of the projecting portions 32 and the number of the recessed portions 80 in the rotor core 30 is N. As described above, since the number of the virtual lines S1 is the same as the total number of the projecting portions 32 and the recessed portions 80, the number of the virtual lines S1 is also N. Therefore, in the present embodiment, when a predetermined angle at which the plate member 30a constituting the rotor core 30 is rotated and laminated is (, and the number of the virtual lines S1 is N, φ=360[°]/N is satisfied. By satisfying this relationship, it is possible to employ a manufacturing method in which the plate members 130a having the same shape are rotated and laminated to form the laminated body 130, and a plurality of the recessed portions 80 are formed by scraping off a portion where a plurality of the projecting portions 132 are formed. By the above, even in a case where the projecting portion 32 and a plurality of the recessed portions 80 are provided in the rotor core 30 having a plurality of the plate members 30a that are rotated and laminated, shapes of the plate members 130a rotated and laminated when the laminated body 130 is manufactured can be the same. Therefore, it is possible to use one type of mold for punching the plate member 130a from a base material, and it is possible to suppress increase in manufacturing cost of the rotor 10.

Although not illustrated, the rotor core 30 may have a hole portion different from the first magnet holes 51a and 51b and the through hole 30h described above. In this case, for example, when viewed in the axial direction, the hole portion is provided at a position overlapping an inter-magnetic pole center line Lq that passes through the center in the circumferential direction between the magnet holding portions 31 adjacent in the circumferential direction and extends in the radial direction. By providing the hole portion, weight of the rotor core 30 can be reduced. The inter-magnetic pole center line Lq passes through on a q axis of the rotor 10 when viewed in the axial direction. A direction where the inter-magnetic pole center line Lq extends is a q-axis direction of the rotor 10. The inter-magnetic pole center line Lq is provided for each space between the magnet holding portions 31. A direction in which the magnetic pole center line Ld extends and a direction in which the inter-magnetic pole center line Lq extends are directions intersecting each other. The magnetic pole center line Ld and the inter-magnetic pole center line Lq are alternately provided along the circumferential direction.

The hole portion can be a hole penetrating the rotor core 30 in the axial direction. Note that the hole portion may be a hole having a bottom portion in the axial direction. For example, a plurality of the hole portions are provided at intervals in the circumferential direction. For example, eight of the hole portions can be provided. Each of the hole portions is arranged, for example, on the inner side in the radial direction between the magnet holding portions 31 adjacent to each other in the circumferential direction. Each of the hole portions is located on the inner side in the radial direction of the first magnet hole 51a in one of the magnet holding portions 31 adjacent to each other in the circumferential direction and the first magnet hole 51b in another one of the magnet holding portions 31.

The hole portion may have, for example, a substantially triangular shape with rounded corners protruding to the outer side in the radial direction when viewed in the axial direction. When viewed in the axial direction, for example, the inter-magnetic pole center line Lq passes through the center in the circumferential direction of the hole portion. The hole portion has, for example, a line-symmetric shape with the inter-magnetic pole center line Lq passing through the hole portion as a symmetry axis when viewed in the axial direction.

As illustrated in FIG. 1, the drive device 100 in the present embodiment is provided with the flow path 90 through which the oil O as a refrigerant flows. In the present embodiment, the flow path 90 is a flow path for supplying the oil O stored in the gear housing 63b to the rotor 10 and the stator 61. The flow path 90 is provided with a pump 96 and a cooler 97. The flow path 90 includes a first flow path portion 91, a second flow path portion 92, a third flow path portion 93, a fourth flow path portion 94, and a fifth flow path portion 95.

The first flow path portion 91, the second flow path portion 92, and the third flow path portion 93 are provided in a wall portion of the gear housing 63b, for example. The first flow path portion 91 connects a portion storing the oil O inside the gear housing 63b and the pump 96. The second flow path portion 92 connects the pump 96 and the cooler 97. The third flow path portion 93 connects the cooler 97 and the fourth flow path portion 94. In the present embodiment, the third flow path portion 93 is connected to an end portion on the one side in the axial direction (+Y side) of the fourth flow path portion 94, that is, an upstream side portion of the fourth flow path portion 94.

In the present embodiment, the fourth flow path portion 94 has a tubular shape extending in the axial direction. In other words, in the present embodiment, the fourth flow path portion 94 is a pipe extending in the axial direction. Both end portions in the axial direction of the fourth flow path portion 94 are supported by the motor housing 63a. An end portion on the one side in the axial direction (+Y side) of the fourth flow path portion 94 is supported by, for example, the partition wall portion 63d. An end portion on the other side in the axial direction (−Y side) of the fourth flow path portion 94 is supported by, for example, the lid portion 63e. The fourth flow path portion 94 is located on the outer side in the radial direction of the stator 61. In the present embodiment, the fourth flow path portion 94 is located above the stator 61.

The fourth flow path portion 94 has a supply port 94a for supplying the oil O to the stator 61. In the present embodiment, the supply port 94a is an injection port that injects a part of the oil O flowing into the fourth flow path portion 94 to the outside of the fourth flow path portion 94. The supply port 94a is constituted by a hole penetrating a wall portion of the fourth flow path portion 94 from an inner peripheral surface to an outer peripheral surface. A plurality of the supply ports 94a are provided in the fourth flow path portion 94.

The fifth flow path portion 95 connects the fourth flow path portion 94 and the inside of the shaft 20 that is hollow. More specifically, the fifth flow path portion 95 connects an end portion on the other side in the axial direction (−Y side) of the fourth flow path portion 94 and an end portion on the other side in the axial direction of the shaft 20. In the present embodiment, the fifth flow path portion 95 is provided in the lid portion 63e.

As illustrated in FIG. 1, when the pump 96 is driven, the oil O stored in the gear housing 63b is sucked up through the first flow path portion 91, and flows into the cooler 97 through the second flow path portion 92. The oil O flowing into the cooler 97 is cooled in the cooler 97, and then flows to the fourth flow path portion 94 through the third flow path portion 93. A part of the oil O flowing into the fourth flow path portion 94 is injected from the supply port 94a and supplied to the stator 61. Another part of the oil O flowing into the fourth flow path portion 94 flows into the shaft 20 through the fifth flow path portion 95.

The oil O flowing into the shaft 20 from the fifth flow path portion 95 flows in a direction to the one side in the axial direction (+Y side direction) in the axial direction in the shaft 20. A part of the oil O flowing inside the shaft 20 flows from the hole portion 22 of the shaft 20 into a groove provided in a plate arranged between the core piece portions described above. The oil O flowing into the groove flows to the outer side in the radial direction and flows into the above-described hole portion (not illustrated). The oil O flowing into the hole portion flows in the axial direction and scatters to the outer side in the radial direction toward the stator 61 from an end portion in the axial direction of the rotor core 30 as illustrated in FIG. 1.

Another part of the oil O flowing inside the shaft 20 is discharged from an opening on the one side in the axial direction of the shaft 20 to the inside of the gear housing 63b and stored again in the gear housing 63b. The oil O supplied from the supply port 94a and the hole portion described above (not illustrated) to the stator 61 falls downward and accumulates in a lower region in the motor housing 63a. The oil O accumulated in a lower region in the motor housing 63a returns into the gear housing 63b via the partition wall opening 63f provided in the partition wall portion 63d.

Hereinafter, an embodiment different from the above-described first embodiment will be described. In the description of each embodiment below, a similar configuration to that of the first embodiment described above may be denoted by the same reference sign as appropriate so as to be omitted from description. Further, as a configuration where description is omitted in each embodiment below, a similar configuration to that of the first embodiment described above can be employed in a range where no conflict arises.

### Second Embodiment

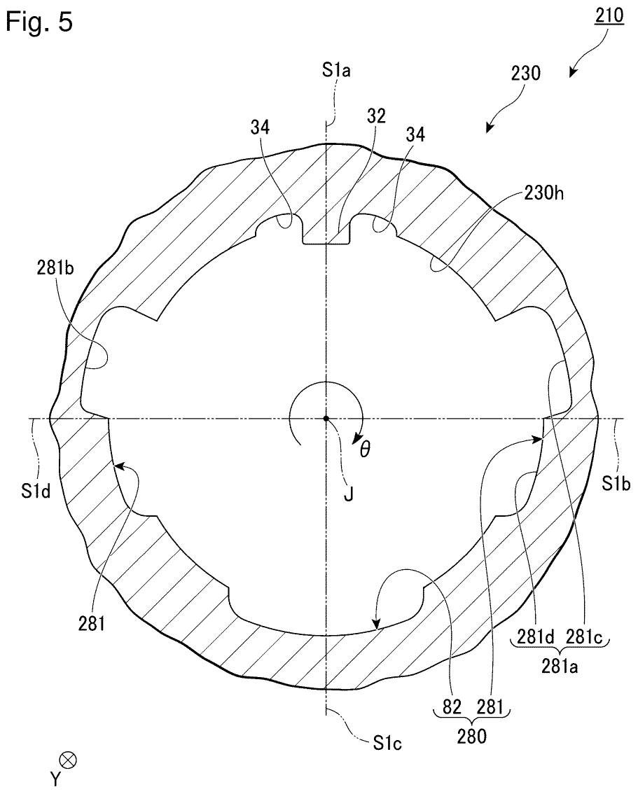

As illustrated in FIG. 5, in a rotor core 230 of a rotor 210 in the present embodiment, three recessed portions 280 are provided at a radially inner edge portion of a through hole 230h. Three of the recessed portions 280 include two first recessed portions 281 and one of the second recessed portion 82. Two of the first recessed portions 281 include a first recessed portion 281a and a first recessed portion 281b. The first recessed portion 281a overlaps the virtual line S1b when viewed in the axial direction. The first recessed portion 281b overlaps the virtual line S1d when viewed in the axial direction. The center in the circumferential direction of the first recessed portion 281a overlaps the virtual line S1b when viewed in the axial direction. The center in the circumferential direction of the first recessed portion 281b overlaps the virtual line S1d when viewed in the axial direction. That is, in the present embodiment, when viewed in the axial direction, an arrangement relationship in the circumferential direction of the first recessed portion 281 with respect to the virtual lines S1b and S1d closest to the first recessed portion 281 in the circumferential direction is the same as an arrangement relationship in the circumferential direction of the second recessed portion 82 with respect to the virtual line S1c overlapping the second recessed portion 82.

In the present embodiment, a dimension in the circumferential direction of the first recessed portion 281 is the same as a dimension in the circumferential direction of the second recessed portion 82. A dimension in the circumferential direction of a first portion 281c located on the side (−θ side) closer to the projecting portion 32 in the circumferential direction than the virtual line S1b in the first recessed portion 281a is the same as a dimension in the circumferential direction of a second portion 281d located on the side (+θ side) farther from the projecting portion 32 in the circumferential direction than the virtual line S1b in the first recessed portion 281a. The first portion 281c is recessed to the outer side in the radial direction from the second portion 281d. The first recessed portion 281a has an asymmetric shape across the virtual line S1b passing through the first recessed portion 281a when viewed in the axial direction. Space volume inside the first portion 281c is larger than space volume inside the second portion 281d. In the present embodiment, space volume inside the first recessed portion 281 is larger than space volume inside the second recessed portion 82.

When viewed in the axial direction, a shape of the first recessed portion 281a is different from a shape of the second recessed portion 82. Further, when viewed in the axial direction, a shape of the first recessed portion 281b is similar to a shape of the first recessed portion 281a except that the first recessed portion 281b is symmetrically arranged across the virtual lines S1a and S1c, and is different from a shape of the second recessed portion 82. That is, in the present embodiment, the first recessed portion 281 has a shape different from that of the second recessed portion 82 when viewed in the axial direction. By making a shape of the first recessed portion 281 different from a shape of the second recessed portion 82 in this manner, it is easy to make the first recessed portion 281 have a shape that offsets a weight balance change in the circumferential direction of the rotor 10 due to provision of the projecting portion 32. By the above, also when the projecting portion 32 is provided at a radially inner edge portion of the through hole 230h, it is possible to suppress displacement of the center of gravity of the rotor 210 with respect to the central axis J. Therefore, when the rotor 210 rotates, vibration of the rotor 210 can be suppressed, and generation of noise can be suppressed.

In the present embodiment, the first portion 281c on the side closer to the projecting portion 32 in the circumferential direction in the first recessed portion 281 is recessed to the outer side in the radial direction than the second portion 281d on the side farther from the projecting portion 32 in the circumferential direction in the first recessed portion 281, so that space volume in a portion provided in a portion close to the projecting portion 32 in the first recessed portion 281 can be increased. By the above, a weight balance change in the circumferential direction of the rotor core 230 due to provision of the projecting portion 32 can be suitably offset by providing the first recessed portion 281. Therefore, it is possible to further suppress displacement of the center of gravity of the rotor 210 with respect to the central axis J.

As described above, in the first embodiment described above, a weight change of the rotor core 30 due to provision of the projecting portion 32 is offset by shifting the first recessed portion 81 in the circumferential direction in a direction of approaching the projecting portion 32, whereas in the present embodiment, a weight change of the rotor core 230 due to provision of the projecting portion 32 is offset by expanding a portion close to the projecting portion 32 in the circumferential direction in the first recessed portion 281 to the outer side in the radial direction to increase space volume in the inside.

Other configurations of the through hole 230h are similar to other configurations of the through hole 30h of the first embodiment. Other configurations of the rotor core 230 are similar to other configurations of the rotor core 30 according to the first embodiment.

### Third Embodiment

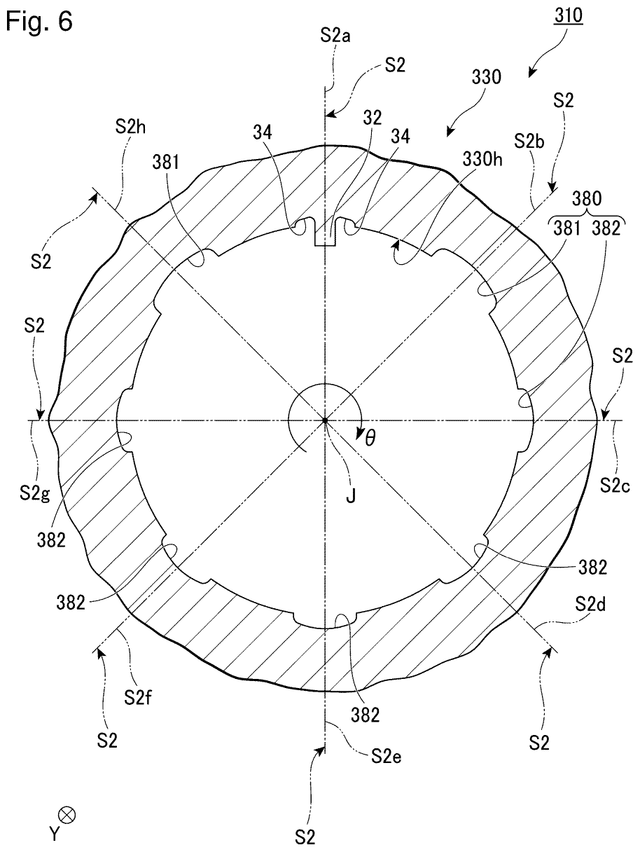

As illustrated in FIG. 6, in the present embodiment, when viewed in the axial direction, a plurality of virtual lines S2 extending to the outer side in the radial direction from the central axis J, arranged at equal intervals in the circumferential direction, and as many as the total number of the number of the projecting portions 32 and the number of recessed portions 380 are defined, and description is made. In the present embodiment, the number of the projecting portions 32 is one, and the number of the recessed portions 380 is seven. Therefore, in the present embodiment, a total of eight virtual lines S2a to S2h are provided as a plurality of the virtual lines S2. Eight of the virtual lines S2a to S2h are arranged at intervals of 45° in the circumferential direction. The virtual line S2a is the virtual line S2 overlapping the center in the circumferential direction of the projecting portion 32 when viewed in the axial direction. The virtual line S2b, the virtual line S2c, the virtual line S2d, the virtual line S2e, the virtual line S2f, the virtual line S2g, and the virtual line S2h are arranged at an interval of 45° from each other in this order from the virtual line S2a toward the one side in the circumferential direction (+θ side). In the present embodiment, a predetermined angle at which plate members constituting a rotor core 330 are rotated and laminated is 45°.

Each of the recessed portions 380 overlaps each of the virtual lines S2b to S2h when viewed in the axial direction. A plurality of the recessed portions 380 include a first recessed portion 381 and a second recessed portion 382. Two of the first recessed portions 381 are provided. Five of the second recessed portions 382 are provided. Two of the first recessed portions 381 are the recessed portions 380 with the projecting portion 32 interposed between them in the circumferential direction and are arranged adjacent to the projecting portion 32 in the circumferential direction. One of the first recessed portions 381 overlaps the virtual line S2b when viewed in the axial direction. Another one of the first recessed portions 381 overlaps the virtual line S2h when viewed in the axial direction. The centers in the circumferential direction of the first recessed portions 381 overlap the virtual lines S2b and S2h when viewed in the axial direction.

Five of the second recessed portions 382 overlap five of the virtual lines S2c, S2d, S2e, S2f, and S2g when viewed in the axial direction. The centers of the circumferential direction of the second recessed portions 382 overlap the virtual lines S2c, S2d, S2e, S2f, and S2g when viewed in the axial direction. In the present embodiment, when viewed in the axial direction, a shape of the first recessed portion 381 and a shape of the second recessed portion 382 are similar to each other, and are the same. When viewed in the axial direction, a shape of the first recessed portion 381 and a shape of the second recessed portion 382 are, for example, the same as a shape of the recessed portion 80 of the first embodiment.

In the present embodiment, space volume inside the first recessed portion 381 is larger than space volume inside the second recessed portion 382. When viewed in the axial direction, size of the first recessed portion 381 is larger than size of the second recessed portion 382. A dimension in the radial direction of the first recessed portion 381 is larger than a dimension in the radial direction of the second recessed portion 382. A dimension in the circumferential direction of the first recessed portion 381 is larger than a dimension in the circumferential direction of the second recessed portion 382. That is, in the present embodiment, the first recessed portion 381 satisfies that the first recessed portion 381 has a dimension in the circumferential direction different from that of the second recessed portion 382 when viewed in the axial direction. For this reason, it is easy to set a dimension in the circumferential direction of the first recessed portion 381 to a dimension that offsets a weight balance change in the circumferential direction of the rotor 310 due to provision of the projecting portion 32. By the above, also when the projecting portion 32 is provided at a radially inner edge portion of a through hole 330h, it is possible to suppress displacement of the center of gravity of the rotor 310 with respect to the central axis J. Therefore, when the rotor 310 rotates, vibration of the rotor 310 can be suppressed, and generation of noise can be suppressed.

As described above, in the present embodiment, among a plurality of the recessed portions 380 arranged at equal intervals in the circumferential direction together with the projecting portion 32, two of the recessed portions 380 arranged adjacent to each other on both sides in the circumferential direction of the projecting portion 32 are set as the first recessed portions 381 to have a dimension in the circumferential direction larger than that of another one of the recessed portions 380, so that a weight change of the rotor core 330 due to provision of the projecting portion 32 is suitably offset. Further, in the present embodiment, the first recessed portion 381 has the same shape as the second recessed portion 382 when viewed in the axial direction, and the first recessed portion 381 is larger than the second recessed portion 382, so that a weight change of the rotor core 330 due to provision of the projecting portion 32 is suitably offset.

The present invention is not limited to the above-described embodiment, and other configurations and other methods can be employed within the scope of the technical idea of the present invention. The first recessed portion only needs to satisfy at least one of the following conditions: having an arrangement relationship in the circumferential direction with respect to a virtual line closest to the first recessed portion in the circumferential direction when viewed in the axial direction that is different from an arrangement relationship in the circumferential direction of the second recessed portion with respect to a virtual line overlapping the second recessed portion; having a shape different from that of the second recessed portion when viewed in the axial direction; and having a dimension in the circumferential direction different from that of the second recessed portion when viewed in the axial direction. The first recessed portion may satisfy any two or all of the three conditions. Further, in a case where a plurality of the first recessed portions are included, a plurality of the first recessed portions may include two or more of the first recessed portions satisfying different ones among the three conditions above. The first recessed portion does not need to overlap a defined virtual line when viewed in the axial direction. The number of the first recessed portions is not particularly limited as long as the number is one or more. A shape of the first recessed portion is not particularly limited.

A shape of the second recessed portion is not particularly limited. The second recessed portion may be arranged in any manner with respect to a virtual line as long as the second recessed portion overlaps the virtual line when viewed in the axial direction. The number of the second recessed portions is not particularly limited as long as the number is one or more. Arrangement in the circumferential direction of the first recessed portion and the second recessed portion is not particularly limited.

In a case where the rotor core has a plurality of plate members laminated in the axial direction, a plurality of the plate members may be rotated and laminated at any predetermined angle. When the predetermined angle is φ and the number of virtual lines is N, φ=360[°]/N does not need to be satisfied. In this case, for example, φ>360[°]/N may be satisfied. A plurality of the plate members do not need to be rotated and laminated.

The number of the projecting portions provided at a radially inner edge portion of the through hole is not particularly limited as long as the number is one or more. A circumferential position of the projecting portion is not particularly limited. The projecting portion does not need to overlap a magnetic pole center line passing through the center in the circumferential direction of the magnetic pole portion and extending in the radial direction when viewed in the axial direction. The projecting portion may overlap the inter-magnetic pole center line Lq of the above-described embodiment when viewed in the axial direction. The depressed portion does not need to be provided on both sides in the circumferential direction of the projecting portion.

Arrangement of magnets fixed to the rotor core and the number of magnets are not particularly limited. For example, in addition to a pair of the first magnet holes 51a and 51b and a pair of the first magnets 41a and 41b in the above-described embodiment, a second magnet hole located on the outer side in the radial direction of the first magnet holes 51a and 51b and a second magnet arranged in the second magnet hole may be provided. In this case, for example, in each magnetic pole portion, a pair of the second magnet holes and the second magnets may be provided so as to sandwich the magnetic pole center line Ld in the circumferential direction when viewed in the axial direction. In this case, a pair of the second magnet holes and a pair of the second magnets may extend in directions away from each other in the circumferential direction from the inner side in the radial direction toward the outer side in the radial direction when viewed in the axial direction. More specifically, a pair of the second magnet holes and a pair of the second magnets may be arranged along a V shape expanding in the circumferential direction toward the outer side in the radial direction when viewed in the axial direction. As described above, in each magnetic pole portion of the rotor, two pairs of the magnets may be provided in a manner that pairs of the magnets arranged along a V shape as viewed in the axial direction are arranged in the radial direction. Note that one of the second magnet hole and one of the second magnet may be provided in each magnetic pole portion, and may extend in a direction orthogonal to the magnetic pole center line Ld when viewed in the axial direction. In this case, in each magnetic pole portion of the rotor, one pair of the first magnets and one of the second magnet may be arranged along a V shape when viewed in the axial direction.

The rotating electric machine to which the present invention is applied is not limited to a motor, and may be a generator. The application of the rotating electric machine is not particularly limited. The rotating electric machine may be mounted in equipment other than a vehicle. The application of the drive device to which the present invention is applied is not particularly limited. For example, the drive device may be mounted in a vehicle for an application other than the application of rotating an axle, or may be mounted in equipment other than a vehicle. A posture when the rotating electric machine and the drive device are used is not particularly limited. A central axis of the rotating electric machine may be inclined with respect to the horizontal direction orthogonal to the vertical direction or may extend in the vertical direction.

Note that the present technique can have a configuration as described below.
(1) A rotor rotatable about a central axis, the rotor including a shaft extending in an axial direction, and a rotor core fixed to the shaft, in which the rotor core includes a through hole through which the shaft passes in the axial direction, a projecting portion provided at a radially inner edge portion of the through hole and protruding to an inner side in a radial direction, and a plurality of recessed portions provided at intervals in a circumferential direction in a radially inner edge portion of the through hole and recessed to an outer side in the radial direction, when a plurality of virtual lines extending to an outer side in the radial direction from the central axis, arranged at equal intervals in the circumferential direction, and as many as a total number of a number of the projecting portions and a number of the recessed portions when viewed in the axial direction are defined, one of a plurality of the virtual lines overlaps a center in the circumferential direction of the projecting portion when viewed in the axial direction, a plurality of the recessed portions include a first recessed portion, and a second recessed portion overlapping the virtual line when viewed in the axial direction, and the first recessed portion satisfies at least one of following conditions: the first recessed portion has an arrangement relationship in the circumferential direction with respect to the virtual line closest to the first recessed portion in the circumferential direction when viewed in the axial direction that is different from an arrangement relationship in the circumferential direction of the second recessed portion with respect to the virtual line overlapping the second recessed portion; the first recessed portion has a shape different from that of the second recessed portion when viewed in the axial direction; and the first recessed portion has a dimension in the circumferential direction different from that of the second recessed portion when viewed in the axial direction.
(2) The rotor according to (1), in which the first recessed portion has an asymmetrical shape that overlaps the virtual line and is across the virtual line passing through the first recessed portion when viewed in the axial direction.
(3) The rotor according to (2), in which when viewed in the axial direction, a dimension in the circumferential direction of a portion closer to the projecting portion in the circumferential direction than the virtual line in the first recessed portion is larger than a dimension in the circumferential direction of a portion farther from the projecting portion in the circumferential direction than the virtual line in the first recessed portion.
(4) The rotor according to any one of (1) to (3), in which the first recessed portion is arranged at a position closer to the projecting portion in the circumferential direction than the second recessed portion.
(5) The rotor according to any one of (1) to (4), in which the recessed portion arranged adjacent to the projecting portion in the circumferential direction among a plurality of the recessed portions is the first recessed portion.
(6) The rotor according to any one of (1) to (5), in which a plurality of the recessed portions have the same shape as each other when viewed in the axial direction.
(7) The rotor according to any one of (1) to (6), in which the second recessed portion has a line-symmetrical shape with the virtual line passing through the second recessed portion when viewed in the axial direction as a symmetry axis.
(8) The rotor according to (7), in which a plurality of the recessed portions include the recessed portion arranged on an opposite side to the projecting portion across the central axis in the radial direction, and the recessed portion arranged on an opposite side to the projecting portion across the central axis in the radial direction is the second recessed portion.
(9) The rotor according to any one of (1) to (8), in which the rotor core includes a plurality of plate members laminated in the axial direction, the plate members are laminated in a state of being rotated at a predetermined angle one or multiple at a time, and when the predetermined angle is φ and the number of the virtual lines is N, φ=360[°]/N is satisfied.
(10) The rotor according to any one of (1) to (9) further including a plurality of magnetic pole portions arranged at intervals in the circumferential direction, in which the projecting portion is arranged at a position overlapping a magnetic pole center line passing through a center in the circumferential direction of the magnetic pole portion and extending in the radial direction when viewed in the axial direction.
(11) The rotor according to any one of (1) to (10), in which a pair of depressed portions recessed to an outer side in the radial direction is provided in a radially inner edge portion of the through hole, and the pair of depressed portions sandwiches the projecting portion in the circumferential direction and are arranged adjacent to the projecting portion.
(12) A rotating electric machine, including the rotor according to any one of (1) to (11), and a stator facing the rotor with a gap interposed between them in a radial direction.
(13) A drive device including the rotating electric machine according to (12), and a gear mechanism connected to the rotating electric machine.

The configurations described above in the present description may be appropriately combined in a range where no conflict arises.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A rotor rotatable about a central axis, the rotor comprising:
a shaft extending in an axial direction; and
a rotor core fixed to the shaft,
wherein
the rotor core includes:
a through hole through which the shaft passes in the axial direction;
a projecting portion provided at a radially inner edge portion of the through hole and protruding to an inner side in a radial direction; and
a plurality of recessed portions provided at intervals in a circumferential direction in a radially inner edge portion of the through hole and recessed to an outer side in the radial direction,
when a plurality of virtual lines extending to an outer side in the radial direction from the central axis, arranged at equal intervals in the circumferential direction, and as many as a total number of a number of the projecting portions and a number of the recessed portions when viewed in the axial direction are defined, one of the plurality of virtual lines overlaps a center in the circumferential direction of the projecting portion when viewed in the axial direction,
the plurality of recessed portions include:
a first recessed portion; and
a second recessed portion overlapping the virtual line when viewed in the axial direction, and
the first recessed portion satisfies at least one of following conditions:
the first recessed portion has an arrangement relationship in the circumferential direction with respect to the virtual line closest to the first recessed portion in the circumferential direction when viewed in the axial direction that is different from an arrangement relationship in the circumferential direction of the second recessed portion with respect to the virtual line overlapping the second recessed portion;
the first recessed portion has a shape different from that of the second recessed portion when viewed in the axial direction; and
the first recessed portion has a dimension in the circumferential direction different from that of the second recessed portion when viewed in the axial direction.

2. The rotor according to claim 1, wherein the first recessed portion has an asymmetrical shape that overlaps the virtual line and is across the virtual line passing through the first recessed portion when viewed in the axial direction.

3. The rotor according to claim 2, wherein when viewed in the axial direction, a dimension in the circumferential direction of a portion closer to the projecting portion in the circumferential direction than the virtual line in the first recessed portion is larger than a dimension in the circumferential direction of a portion farther from the projecting portion in the circumferential direction than the virtual line in the first recessed portion.

4. The rotor according to claim 1, wherein the first recessed portion is arranged at a position closer to the projecting portion in the circumferential direction than the second recessed portion.

5. The rotor according to claim 1, wherein the recessed portion arranged adjacent to the projecting portion in the circumferential direction among the plurality of recessed portions is the first recessed portion.

6. The rotor according to claim 1, wherein the plurality of recessed portions have the same shape as each other when viewed in the axial direction.

7. The rotor according to claim 1, wherein the second recessed portion has a line-symmetrical shape with the virtual line passing through the second recessed portion when viewed in the axial direction as a symmetry axis.

8. The rotor according to claim 7, wherein
the plurality of recessed portions include the recessed portion arranged on an opposite side to the projecting portion across the central axis in the radial direction, and
the recessed portion arranged on an opposite side to the projecting portion across the central axis in the radial direction is the second recessed portion.

9. The rotor according to claim 1, wherein
the rotor core includes a plurality of plate members laminated in the axial direction,
the plate members are laminated in a state of being rotated at a predetermined angle one or multiple at a time, and
when the predetermined angle is φ and a number of the virtual lines is N, φ=360[°]/N is satisfied.

10. The rotor according to claim 1, further comprising a plurality of magnetic pole portions arranged at intervals in the circumferential direction,
wherein the projecting portion is arranged at a position overlapping a magnetic pole center line passing through a center in the circumferential direction of the magnetic pole portion and extending in the radial direction when viewed in the axial direction.

11. The rotor according to claim 1, wherein
a pair of depressed portions recessed to an outer side in the radial direction is provided in a radially inner edge portion of the through hole, and
the pair of depressed portions sandwiches the projecting portion in the circumferential direction and are arranged adjacent to the projecting portion.

12. A rotating electric machine, comprising:
the rotor according to claim 1; and
a stator facing the rotor with a gap interposed between the stator and the rotor in a radial direction.

13. A drive device comprising:
the rotating electric machine according to claim 12; and
a gear mechanism connected to the rotating electric machine.
